(19) United States
(12) Patent Application Publication
(10) Pub. No.: US 2006/0057862 A1
(43) Pub. Date: Mar. 16, 2006

(54) Connecting device

(76) Inventor: Reinhard Oberstarr, Polling (DE)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/226,905

(22) Filed: Sep. 14, 2005

(30) Foreign Application Priority Data
Sep. 14, 2004 (DE) 10 2004 044 430

(51) Int. Cl. H01R 39/00

(52) U.S. Cl. 439/1

(57) ABSTRACT

A system and device for connecting a first electrical connector to a second electrical connector, when at least one of the two electrical connectors in the installed state is positioned between a body part of a vehicle and a trim for the body part (e.g., a roof, a door, a beam, or a floor of the vehicle). A first coupling device selectively connected to the first electrical connector. A second coupling device is selectively connected to the second electrical connector and is electrically matched to the first coupling device to form a connection of the two electrical connectors to one another.

### TECHNICAL FIELD

The invention relates to a device for connecting a first electrical connector to a second electrical connector, where in the installed state, at least one of the two electrical connectors is situated between a body part of a vehicle (e.g., the roof, a door, a beam, or the floor of the vehicle) and a trim for the body part. More specifically, the connecting device includes a first coupling device configured to couple to the first electrical connector and a second coupling device configured to couple to the second electrical connector, the first and second coupling devices configured to provide an electrically matched connection of the two electrical connectors to one another.

### BACKGROUND

Connecting devices of the aforementioned type are known, and generally involve plug-socket combinations. One of the two elements, the plug, for example, is attached to the end of a cable which extends along the interior of the body part of the vehicle and represents, for example, a connection to the vehicle battery. In such a case the associated socket is provided, for example, on a light integrated into the trim for interior lighting of the vehicle.

In the above example, the trim of the vehicle cannot be installed on the body part until the plug has been inserted into the socket. However, in order to accomplish the insertion, the cable must have a certain free length. After the trim is attached to the body part; however, this free length must be stowed between the trim and the body part.

Generally, the longer the cable with the plug on its free end, the simpler the installation. On the other hand, a long cable is problematic because it is often difficult to stow between the trim and the body part of the vehicle.

### SUMMARY OF INVENTION

Embodiments of the invention refine the connecting device of the aforementioned type in such a way that the installation is simple, yet only requiring a particularly small length of cable to be stowed between trim and a body part of a vehicle (e.g., the roof, a door, a beam, or the floor of the vehicle). Accordingly, this desired result may be achieved in one embodiment of the invention by attaching the first coupling device to the body part.

One embodiment of the invention attaches the coupling device to the body part may make use of the body part as an abutment in establishing a connection of the two coupling devices so that it is not necessary to establish the connection before attaching the trim to the body part. Instead, when the first coupling device is attached to the body part it is possible to join the two coupling devices together at the same time that the trim is attached to the body part. In one embodiment, the two coupling devices are thus configured to be joined together in a manner similar to two parts of a pushbutton.

To further simplify installation and, in particular with regard to production tolerances for the trim and the two coupling devices, according to one embodiment of the invention it is particularly preferred that the first coupling device is attached to the body part in a floating manner. In other words, according to one embodiment of the invention, the first coupling device on account of its floating attachment compensates for production tolerances and minor imprecision in the attachment of the trim to the body part. The first coupling device also compensates for tolerances of fastening elements such as pins or pushbuttons, and in the attachment of these fastening elements.

The first coupling device is preferably displaceable in the direction transverse to a direction of motion for coupling the first and second coupling devices to one another. Specifically, values of displacement that have proved to be particularly suitable for the previously intended purpose include for example displacement by about 1.0 mm to about 9.0 mm, preferably about 2.0 mm to about 8.0 mm, particularly preferably about 3.0 mm to about 7.0 mm.

It is expressly noted that a direction transverse to the direction of motion for coupling does not necessarily have to be a rectilinear direction; but rather, a pivoting or rotational motion is also possible.

Additionally or alternatively, the first coupling device may be displaceable in the direction of a direction of motion for coupling the first and second coupling devices to one another. For example, the first coupling device may be displaceable by about 0.5 mm to about 5.0 mm. Specifically, the first coupling device may be preferably displaceable by about 1.0 mm to about 4.0 mm. More specifically, the first coupling device may be particularly preferably displaceable by about 1.5 mm to about 3.5 mm. These value ranges for displaceability in particular take into account undulations or bulges of the body part and/or trim.

In one embodiment, a locking device is preferably provided for locking the two coupling devices to one another in the coupled state. This ensures that the connecting device does not accidentally come loose.

In various embodiments, the locking device is preferably designed in the form of a latching device. According to one embodiment of the invention, the latching device automatically engages when the two coupling devices are coupled or joined to one another. The effort required for locking or latching is thereby minimized during installation.

According to further embodiments of the invention, the locking device includes a predetermined capture range, and the first coupling device is displaceable in the direction transverse to a direction of motion for joining the first and second coupling devices together. For example, the first coupling device may be displaceable by a distance corresponding to about ±50% of the capture range. Specifically, the first coupling device may be preferably displaceable by a distance corresponding to about ±20% of the capture range. More specifically, the first coupling device may be particularly preferably displaceable by a distance corresponding to about ±10% of the capture range.

According to various embodiments of the invention the first coupling device is attached to the body part in a floating manner such that coordination is made with the capture range of the locking device. This coordination simplifies the installation. Not only the first coupling device, but also the second coupling device may be attached in a floating manner. Thus, one embodiment of the invention provides for the floating attachment of the second coupling device to the trim.

According to various embodiments of the invention, the first coupling device preferably includes a contact element, which with a first contact region facing the second coupling device in the installed state, makes contact with a second contact region of the second coupling device. According to one embodiment of the invention, an “end face contact” is used, thereby further simplifying the connection.

To make the connection especially secure and in particular to minimize susceptibility to interference, according to one embodiment of the invention the first and/or second contact region is/are displaceable in a direction of motion for coupling, and is/are pretensioned in the contact direction. In this context, this is referred to as a pressure contact.

The first coupling device may be formed from a single component. According to an embodiment of the invention; however, it preferably has a modular design. This results in greater flexibility in the design of the first coupling device without the need for excessive increases in inventory stock. For example, in one embodiment the first coupling device preferably has a signal module, a power module, and/or a holding module. The holding module may have an elastic design to ensure displaceability of the first coupling device in the direction of a direction of motion for coupling.

In some embodiments with a modular design, a tongue and groove connection is preferred for joining the two modules to one another. In at least one embodiment, the tongue and groove connection preferably has a dovetail contour to ensure adequate reliability of same.

### BRIEF DESCRIPTION OF THE DRAWINGS

The invention is explained in greater detail below, based on exemplary embodiments and with reference to the accompanying drawings, which show the following:

FIG. 1 shows a top view of a plug device according to a first preferred exemplary embodiment of the connecting device according to the invention;

FIG. 2 shows a side view of the plug device according to FIG. 1;

FIG. 3 shows a side view of the plug device according to FIG. 1;

FIG. 4 shows two side views of a contact element in the plug device according to FIG. 1;

FIG. 5 shows a perspective view of the plug device according to FIG. 1;

FIG. 6 shows a perspective view of the plug device according to FIG. 1, in cooperation with an associated socket device according to a preferred exemplary embodiment of the invention; and

FIG. 7 shows a perspective view of a plug device according to a second preferred exemplary embodiment of the invention.

### DETAILED DESCRIPTION

In the following detailed description, reference is made to the accompanying drawings, which form a part hereof wherein like numerals designate like parts throughout, and in which are shown, by way of illustration, specific embodiments in which the invention may be practiced. It is to be understood that other embodiments may be utilized and structural or logical changes may be made without departing from the scope of the present invention. Therefore, the following detailed description is not to be taken in a limiting sense, and the scope of the present invention is defined by the appended claims and their equivalents.

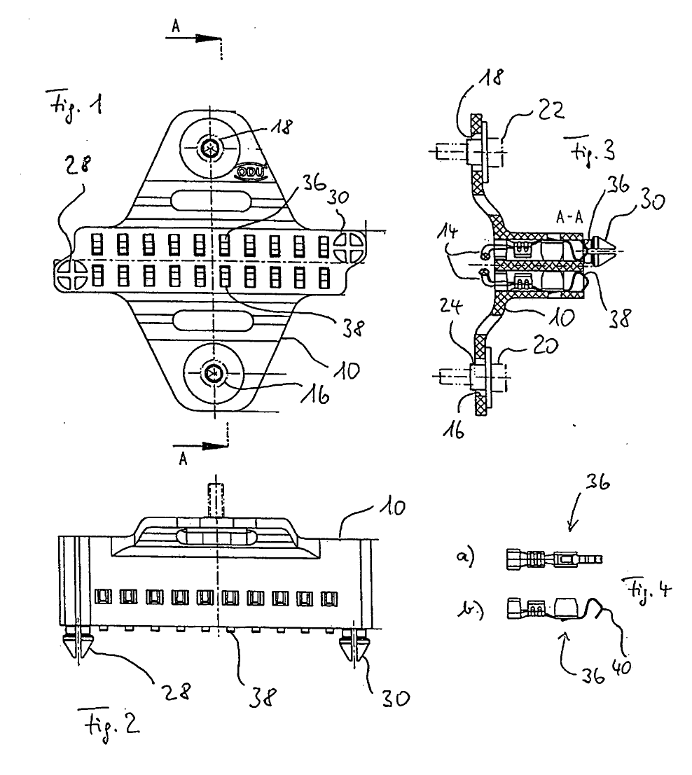

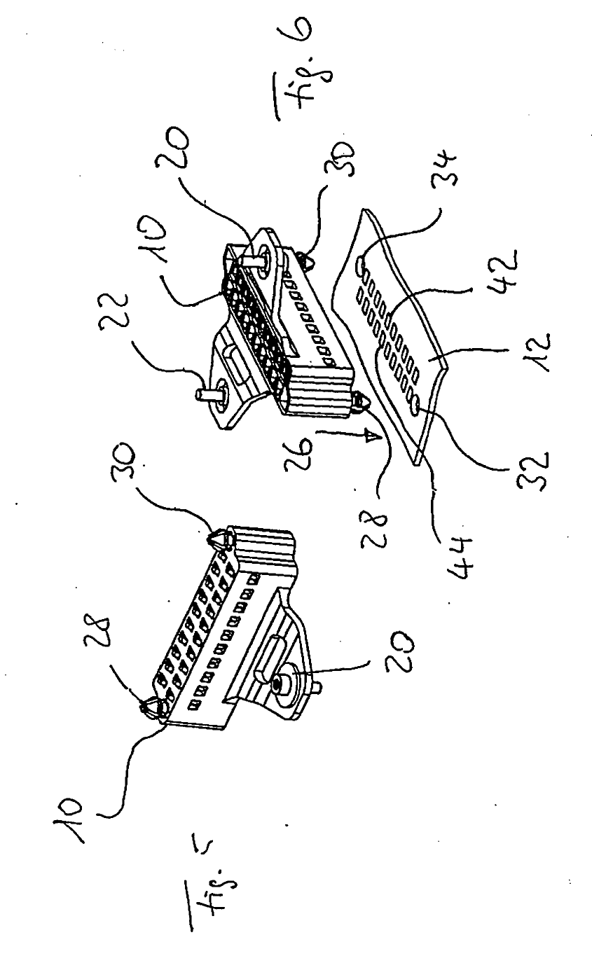

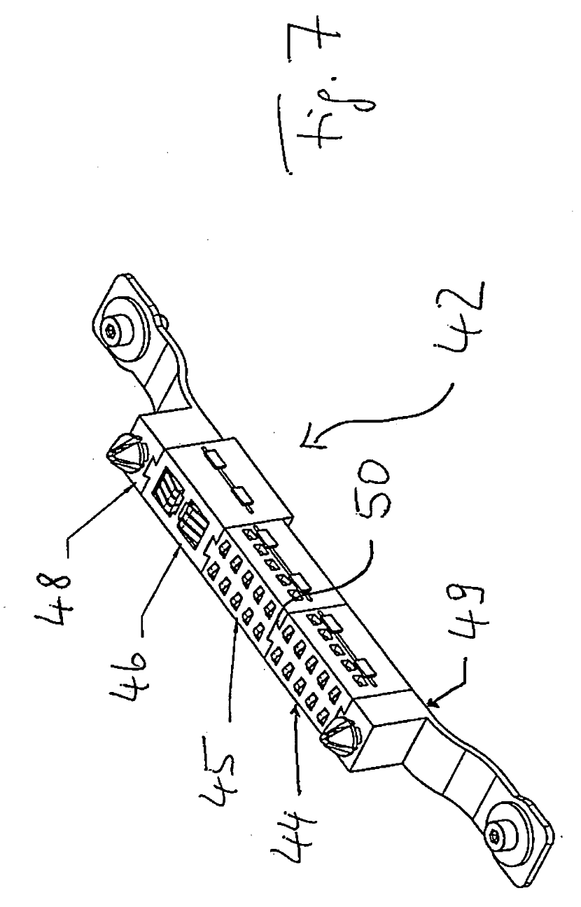

In the first exemplary embodiment of the invention illustrated in FIGS. 1 through 6, the first coupling device is provided by a plug 10. A board 12 is used as the second coupling device. The plug 10 is connected to a cable 14 which represents a first electrical connector. The cable 14 is intended to be electrically connected to wiring (not shown) for the board 12.

In the exemplary embodiment illustrated in the drawing, the cable 14 is electrically connected to an automobile battery (not shown). The board 12 is situated on the back side of a light for backseat lighting (not visible from the interior of the automobile), at least the plug-side end section of the cable 14 running along the automobile roof and being covered by trim. The trim is also referred to as “roof lining.”

The plug 10 has two circular through openings 16 and 18, each defining a passage through plug 10 to accommodate a fastening device, such as screws 20 and 22. Screws 20 and 22 are placed in the openings 16 and 18, respectively, and are screwed to the automobile roof in corresponding threads (not shown). Additionally, or alternatively, pins and/or pushbuttons may be used for fastening.

The following explanations refer to the screw 20 in the through opening 16, but by extension also apply to the screw 22 in the through opening 18.

A section 24 of the screw 20 which in the installed state is situated in the through opening 16 has a diameter which is smaller than the through opening 16. For central positioning, there is an annular gap about 3 mm thick between the screw 20 and the through opening 16. Thus, the plug 10 is able to move by about ±3 mm, i.e., by a total of about 6 mm, in any direction transverse to a direction of motion 26 (FIG. 6) for inserting the plug 10 into the board 12. For example, in at least one embodiment the plug 10 is displaceable in any direction transverse to the direction of motion by about 1.0 mm to about 9.0 mm, preferably about 2.0 mm to about 8.0 mm, and/or particularly preferably about 3.0 mm to about 7.0 mm. In this regard, linear motions are not the only possible motions. Rather, the plug 10 may, for example, also be swiveled around the screw 20, resulting in corresponding relative motions between the opening 18 and the screw 22.

However, the plug 10 is displaceable with respect to the roof not only in directions transverse to the connection direction 26, but also parallel thereto. For example, in at least one embodiment the plug 10 is displaceable in the direction of motion by about 0.5 mm to about 5.0 mm, preferably about 1.0 mm to about 4.0 mm, and/or particularly preferably about 1.5 mm to about 3.5 mm. This parallel displaceability results from the fact that in the installed state, the part 24 of the screw 20 situated inside the through opening 16 is about 3 mm thicker in the axial direction than the part of the plug 10, which surrounds the through opening 16. Additionally, or alternatively, the regions (flanges) of the plug 10 surrounding the through openings 16, 18 may also have an elastic design.

Locking pins 28 and 30 are used to lock or anchor the plug 10 to the board 12. The locking pins 28 and 30 may be radially pushed in against an elastic restoring force. When the plug 10 is coupled to the board 12, the locking pins 28 and 30 enter recesses 32 and 34, respectively, in the board 12 and engage when they have been pushed far enough into the recesses 32, 24. In this manner the plug 10 is locked to the board 12 without mutual play.

The cable 14 is a multi-conductor cable. The individual conductors are provided at their ends with a so-called crimp contact 36 or 38, respectively. FIG. 4 shows two side views of crimp contact 36. Crimp contact 38 has an identical design. A contact region 40 on the front end of the crimp contact 36 is used for contacting with a corresponding contact in the board 12. The contact region 40 is made of spring steel, and is therefore able to yield in the longitudinal direction; i.e., in the direction of the arrow 26 in FIG. 6. The elastic restoring force of the contact region reliably maintains contact with the particular counter-contact on the board 12. Although this is not illustrated in the drawing, the board 12 is also attached to the roof lining in a floating, i.e., displaceable, manner.

To establish a connection of the plug 10 to the board 12, the operation is similar to a pushbutton. Only the roof lining with the board 12 attached thereto is brought into the installation position, in which the board 12 comes to rest opposite from the plug which is attached to the roof of the automobile. When the roof lining is then pressed against the roof, the board 12 is also pressed against the plug 10. Since the plug 10 is attached to the roof, a counterforce acts opposite to the pressure of the board 12 against the plug 10, which in particular causes the locking pins 28 and 30 to be pushed into the respective recesses 32 and 34 and become engaged therein, whereupon the crimp contacts 36 and 40 come into contact with the corresponding counter-contacts on the board 12. Two of the counter-contacts are designated by reference numbers 42 and 44 in FIG. 6.

In the exemplary embodiment shown, both the plug 10 and the board 12 are designed for a 20-conductor connection. Of course, there may also be a greater or lesser number of conductors.

The locking pins 28 and 30 have a capture range of about ±3 mm. Therefore, the annular gap between the screw 20 and the through opening 16 also has a thickness of about 3 mm. This mutual coordination of the geometries simplifies the installation. For example, in at least one embodiment where the locking device has a predetermined capture range, the first coupling device is displaceable in a direction transverse to a direction of motion to couple the first and second coupling devices together by a distance corresponding to about ±50%, preferably about ±20%, and/or particularly preferably about ±10% of the capture range.

FIG. 7 shows a plug 42, which represents an alternative to the plug 10 according to FIGS. 1 through 6. The plug 42 is composed of a total of five modules; namely, two signal modules 44, 45, one power module 46, and two spring and holding modules 48, 49. The modules are joined to one another by a tongue and groove connection 50 having a dovetail contour. The signal modules 44, 45 are used for coupling of signals. The power module 46 is used as the power supply. The spring and holding modules 48, 49 are used for attaching to the body part and ensuring displaceability in the coupling direction.

Thus, it can be seen from the above descriptions that various novel methods, apparatus, and systems to connect different electrical connectors, where the connections are to be positioned between trim and a body part of a vehicle have been described. While described in terms of the earlier described embodiments, those skilled in the art will recognize that the embodiments are not limited to the embodiments described and can be practiced with modification and alteration within the spirit and scope of the appended claims of the non-provisional application to follow. Thus, the description is to be regarded as illustrative instead of restrictive. The features of the invention disclosed in the above descriptions, in the claims, and in the drawing may be useful, both individually and in any combination, for implementing the invention in its various embodiments.

What is claimed is:

1. A device for connecting a first electrical connector to a second electrical connector, at least one of the two electrical connectors in an installed state is situated between a body part of a vehicle and a trim for the body part, the device comprising:
a first coupling device attached to the body part and configured to couple to the first electrical connector; and
a second coupling device configured to couple to the second electrical connector and matched to the first coupling device to connect the first and second electrical connectors to one another.

2. The device according to claim 1, wherein the first coupling device is attached to the body part in a floating manner.

3. The device according to claim 1, wherein the first coupling device is displaceable in a direction transverse to a direction of motion for coupling the first and second coupling devices to one another.

4. The device according to claim 1, wherein the first coupling device is displaceable in a direction of motion for coupling the first coupling device and the second coupling device to one another.

5. The device according to claim 1, wherein the device further comprises a locking device for locking the first and second coupling devices to one another in the coupled state.

6. The device according to claim 5, wherein the locking device is a latching device.

7. The device according to claim 6, wherein the latching device automatically engages when the first and second coupling devices are coupled to one another.

8. The device according to claim 6, wherein the locking device has a predetermined capture range, and that the first coupling device is displaceable in a direction transverse to a direction of motion to couple the first and second coupling devices together.

9. The device according to claim 1, wherein the first coupling device has a contact element and a first contact region both facing the second coupling device in the installed state, the contact element and the first contact region each contacting a second contact region of the second coupling device.

10. The device according to claim 9, characterized in that the first and/or second contact region is/are displaceable in a contact direction substantially parallel to a direction of motion to couple, and is/are pretensioned in the contact direction.

11. The device according to claim 1, wherein the second coupling device is attached to the trim in a floating manner.

12. The device claim 1, wherein the first coupling device comprises a plurality of modules selectively coupled to one another.

13. The device according to claim 12, wherein the plurality of modules comprise a signal module, a power module, and/or a holding module.

14. The device according to claim 12, wherein the plurality of modules comprise a tongue and groove connection to couple two modules to one another.

15. The device according to claim 14, wherein the tongue and groove connection has a dovetail contour.

16. A connection system comprising:
a first electrical connector and a second electrical connector, at least one of the two electrical connectors are configured to be positioned, in an installed state, between a body part of a vehicle and a trim for the body part;
a first coupling device for selectively coupling to said first electrical connector, the first coupling device being configured to couple to a body part of the vehicle; and
a second coupling device for selectively coupling to said second electrical connector, the second coupling device being configured to selectively coupled to the first coupling device in the installed state and being electrically matched to the first coupling device to electrically connect the first and second electrical connectors to one another in the installed state.

17. The system according to claim 16, wherein the body part of the vehicle is a selected one of a roof, a door, a beam, and a floor.

18. The system according to claim 16, wherein the first coupling device and the second coupling device are each configured to attach in a floating manner.

19. The device according to claim 16, wherein the first coupling device is displaceable by about 1.0 mm to about 9.0 mm in a direction substantially transverse to a direction of motion for coupling the first coupling device and the second coupling device to one another.

20. The system according to claim 19, wherein the first coupling device is displaceable by preferably about 2.0 mm to about 8.0 mm in the direction substantially transverse to the direction of motion for coupling the first coupling device and the second coupling device to one another.

21. The system according to claim 20, wherein the first coupling device is displaceable by particularly preferably about 3.0 mm to about 7.0 mm in the direction substantially transverse to the direction of motion for coupling the first coupling device and the second coupling device to one another.

22. The system according to claim 16, wherein the first coupling device is displaceable by about 0.5 mm to about 5.0 mm in a direction substantially similar to a direction of motion for coupling the first coupling device and the second coupling device to one another.

23. The system according to claim 22, wherein the first coupling device is displaceable by preferably about 1.0 mm to about 4.0 mm in a direction substantially similar to the direction of motion for coupling the first coupling device and the second coupling device to one another.

24. The system according to claim 23, wherein the first coupling device is displaceable by particularly preferably about 1.5 mm to about 3.5 mm in a direction substantially similar to the direction of motion for coupling the first coupling device and the second coupling device to one another.

25. The system according to claim 16, further comprising a locking device configured to automatically lock the first coupling device and second coupling device to one another in a coupled state, the locking device having a predetermined capture range, and the first coupling device is displaceable by a distance corresponding to about ±50% of the capture range in a direction substantially transverse to a direction of motion for connecting the first coupling device and the second coupling device together.

26. The system according to claim 25, wherein the first coupling device is displaceable by a distance corresponding to preferably about ±20% of the capture range.

27. The system according to claim 26, wherein the first coupling device is displaceable by a distance corresponding to particularly preferably about ±10% of the capture range.

28. The system according to claim 16, wherein the first coupling device further comprises a contact element configured to connect electrically to a second contact element of the second coupling device in the installed state and a first contact region configured to contact a second contact region of the second coupling device in the installed state.

29. The system according to claim 28, wherein the first contact region and/or the second contact region is/are displaceable in a direction of motion for coupling and is/are pretensioned in a contact direction.

30. The system according to claim 16, wherein the first coupling device comprises a plurality of modules selectively coupled to one another.

31. The system according to claim 30, wherein the plurality of modules comprise a signal module, a power module, and/or a holding module.

32. The system according to claim 30, wherein each module include a tongue connection and/or a groove connection configured to couple two modules to one another.

33. The system according to claim 32, wherein the tongue connection and the groove connection include a dovetail contour.

34. A method comprising:
coupling a first electrical connector to a first coupling device attached to a body part of a vehicle in a floating manner;
coupling a second electrical connector to a second coupling device attached to a trim for the body part in a floating manner; and
attaching the trim to the body part to automatically couple the first coupling device to the second coupling device.

35. The method according to claim 34, said attaching further automatically locks the first coupling device and the second coupling device together.

36. The method according to claim 34, wherein said automatic coupling includes electrically coupling and mechanically coupling of the first coupling device to the second coupling device.
